(19) United States
(12) Patent Application Publication
(10) Pub. No.: US 2025/0316421 A1
(43) Pub. Date: Oct. 9, 2025

(54) MULTILAYER CERAMIC ELECTRONIC COMPONENT AND METHOD FOR PRODUCING THE SAME

(71) Applicant: Murata Manufacturing Co., Ltd., Nagaokakyo-shi (JP)

(72) Inventor: Toshihiko KOBAYASHI, Nagaokakyo-shi (JP)

(21) Appl. No.: 19/234,672

(22) Filed: Jun. 11, 2025

Related U.S. Application Data
(63) Continuation of application No. PCT/JP2023/043945, filed on Dec. 8, 2023.

(30) Foreign Application Priority Data
Dec. 20, 2022 (JP) 2022-202813

(51) Int. Cl. H01G 4/232; H01G 4/008; H01G 4/12; H01G 4/30; H01G 13/00

(52) U.S. Cl. CPC H01G 4/2325; H01G 4/008; H01G 4/12; H01G 4/30; H01G 13/006

(57) ABSTRACT

A multilayer ceramic electronic component includes a ceramic body including laminated ceramic layers and inner electrodes located along interfaces between the ceramic layers, an outer electrode on a surface of the ceramic body and electrically connected to the inner electrodes, and a plating film on the outer electrode. The outer electrode includes an electroconductive metal and glass including silicon. In a cross section along a thickness direction of the outer electrode, twenty or more pores with a major axis of about 20 nm or more and about 600 nm or less are present in a region located in a central portion with respect to the thickness direction and with a dimension of about 1 μm in the thickness direction and a dimension of about 5 μm in a width direction orthogonal to the thickness direction. Hydrogen ions are gasified in the pores so that diffusion of hydrogen ions into the ceramic body is reduced.

### CROSS REFERENCE TO RELATED APPLICATIONS

This application claims the benefit of priority to Japanese Patent Application No. 2022-202813 filed on Dec. 20, 2022 and is a Continuation Application of PCT Application No. PCT/JP2023/043945 filed on Dec. 8, 2023. The entire contents of each application are hereby incorporated herein by reference.

### BACKGROUND OF THE INVENTION

### 1. Field of the Invention

The present invention relates to multilayer ceramic electronic components and methods for producing the same and particularly to the structure of outer electrodes on a surface of a ceramic body included in a multilayer ceramic electronic component and methods for forming the outer electrodes.

### 2. Description of the Related Art

For example, Japanese Unexamined Patent Application Publication No. 1-80011 describes a problem in a multilayer ceramic capacitor, which is a technique of interest to the present invention. Specifically, since hydrogen ions are generated by a chemical reaction during the step of plating the outer electrodes, the hydrogen ions are occluded in the inner electrodes and cause the dielectric ceramic layers around the inner electrodes to be gradually reduced, resulting in deterioration of insulation resistance. A solution described in Japanese Unexamined Patent Application Publication No. 1-80011 to solve this problem is that, when the inner electrodes contain a noble metal (such as a Ag-Pd alloy) as a main component, a metal (such as Ni) that can inactivate the absorption of hydrogen is added to the inner electrodes.

### SUMMARY OF THE INVENTION

In recent years, to reduce material cost, a base metal such as Ni is being increasingly used as the material of the inner electrodes instead of the noble metal such as Ag or Pd. It is described in Japanese Unexamined Patent Application Publication No. 1-80011 that Ni is a metal that can inactivate the absorption of hydrogen. However, according to the studies by the present inventors etc., it has been discovered that, even when the inner electrodes contain Ni, the influence of hydrogen cannot be eliminated completely, and the hydrogen more or less causes deterioration of the insulation resistance of the dielectric ceramic layers.

The same problem can occur not only in the multilayer ceramic capacitor but also in a general multilayer ceramic electronic component including a ceramic body including a plurality of laminated ceramic layers and inner electrodes disposed along the interfaces between the ceramic layers, outer electrodes disposed on the surface of the ceramic body and electrically connected to the inner electrodes, and a plating film on the outer electrodes.

Accordingly, example embodiments of the present invention provide multilayer ceramic electronic components and methods of producing the same, in which the influence on the ceramic layers of hydrogen ions generated by a chemical reaction during the step of plating the outer electrodes is reduced or prevented.

In an example embodiment of the present invention, the structures of the outer electrodes in the multilayer ceramic electronic components are improved, and methods for forming the improved outer electrodes are also provided.

More specifically, a ceramic electronic component according to an example embodiment of the present invention includes a ceramic body including a plurality of laminated ceramic layers and an inner electrode located along an interface between adjacent ones of the ceramic layers, an outer electrode on a surface of the ceramic body and electrically connected to the inner electrode, and a plating film on the outer electrode.

The outer electrode includes an electroconductive metal and glass including silicon. In a cross section of the outer electrode that is taken along a thickness direction of the outer electrode, twenty or more pores with a major axis of about 20 nm or more and about 600 nm or less are present in a region located in a central portion with respect to the thickness direction and having a dimension of about 1 μm in the thickness direction and a dimension of about 5 μm in a width direction orthogonal to the thickness direction, for example.

A multilayer ceramic electronic component production method according to an example embodiment of the present invention is a method for producing a ceramic electronic component including a ceramic body including a plurality of laminated ceramic layers and an inner electrode located along an interface between adjacent ones of the ceramic layers, an outer electrode on a surface of the ceramic body and electrically connected to the inner electrode, and a plating film on the outer electrode, and the method includes preparing an electroconductive material in a sol state that includes (1) an electroconductive metal salt that, when fired, becomes an electroconductive metal serving as an electroconductive component, (2) a glass raw material that, when fired, becomes glass including silicon and includes a metal salt for the glass, and (3) a solvent to dissolve or disperse the electroconductive metal salt and the glass raw material, the glass raw material having a prescribed softening point and a prescribed melting point, applying the electroconductive material to the surface of the ceramic body such that the electroconductive material comes into contact with the inner electrode in order to form the outer electrode, heat-drying the electroconductive material to gelate the electroconductive material, performing firing at a temperature higher than or equal to a softening point of the glass raw material, lower than or equal to a melting point of the glass raw material, and higher than or equal to a melting point of the metal salt for the glass to form the outer electrode, and forming the plating film on the outer electrode.

According to example embodiments of the present invention, hydrogen ions generated during plating and attempting to enter the outer electrode are gasified in the pores in the outer electrode and thus are reduced or prevented from diffusing into the ceramic body, so that the influence of the hydrogen ions on the ceramic layers can be reduced or prevented.

In a multilayer ceramic electronic component production method according to an example embodiment of the present invention, the electroconductive metal salt included in the electroconductive material to form the outer electrode undergoes volume shrinkage when converted to the metal by heat drying and firing, and the firing temperature is selected to be higher than or equal to the softening point of the glass and lower than or equal to its melting point, so that pores are generated. In this case, since the electroconductive material is in a sol state, the electroconductive metal salt and the glass raw material that are of the order of nanometers are in a highly dispersed state. Therefore, even in thin outer electrodes having a film thickness of, for example, about 1 μm, a large number of submicron pores with a major axis of about 20 nm or more and about 600 nm or less, for example, can be uniformly generated.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a cross-sectional view schematically illustrating a multilayer ceramic capacitor 1 that is a multilayer ceramic electronic component according to an example embodiment of the present invention.

FIG. 2 is an enlarged cross-sectional view schematically illustrating a portion in which an outer electrode 6 of the multilayer ceramic capacitor 1 shown in FIG. 1 is disposed.

FIG. 3 is an SIM image of a multilayer ceramic capacitor that is specimen 5 produced in Experimental Examples, the SIM image being an FIB cross section of a portion in which the outer electrode 6 of the multilayer ceramic capacitor is provided and which corresponds to a portion of the region shown in FIG. 2.

### DETAILED DESCRIPTION OF THE EXAMPLE EMBODIMENTS

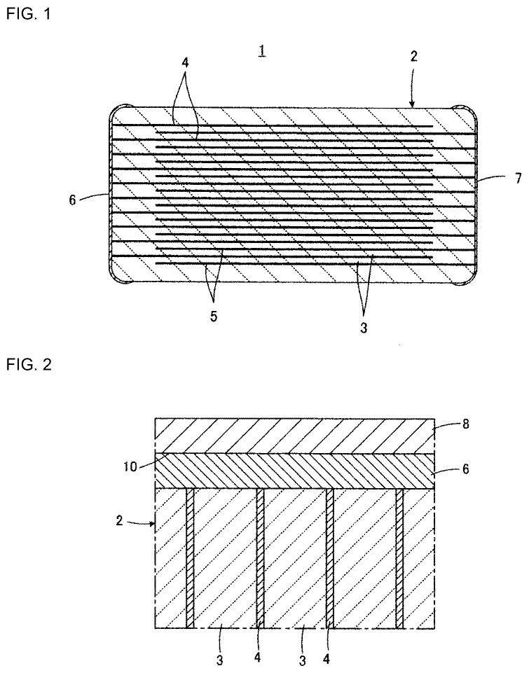

Referring to FIG. 1, the structure of a multilayer ceramic capacitor 1 that is a multilayer ceramic electronic component according to an example embodiment of the present invention will be described.

The multilayer ceramic capacitor 1 includes a ceramic body 2. The ceramic body 2 includes a plurality of laminated ceramic layers 3 and a plurality of inner electrodes 4 and 5 located along interfaces between the plurality of ceramic layers 3. The inner electrodes 4 and 5 are classified into first inner electrodes 4 and second inner electrodes 5 that are alternately arranged in the laminating direction of the ceramic body 2. I first outer electrode 6 and a second outer electrode 7 are provided on the surface of the ceramic body 2, more specifically on its respective opposing end surfaces. The first outer electrode 6 is electrically connected to the first inner electrodes 4, and the second outer electrode 7 is electrically connected to the second inner electrodes 5.

The ceramic layers 3 include, for example, of a dielectric ceramic including ABO₃ (wherein A is at least one of Ba, Ca, and Sr, and B is at least one of Ti and Zr) as a main component. The dielectric ceramic including ABO₃ as a main component may further contain at least one of Mn, Mg, Si, Y, Dy, and Gd as a subcomponent.

Preferably, the inner electrodes 4 and 5 include, as an electroconductive component, an electroconductive metal or an alloy including the electroconductive metal such as at least one selected from nickel, copper, silver, and a silver/palladium alloy.

The outer electrodes 6 and 7 are formed by applying an electroconductive material described later to end surfaces of the ceramic body 2 such that the electroconductive material comes into contact with end portions of the inner electrodes 4 and 5, then heat-drying the applied electroconductive material, and baking the dried electroconductive material. FIG. 2 is a cross-sectional view showing a portion of the first outer electrode 6. The second outer electrode 7 is not shown in FIG. 2 but has substantially the same structure as the first outer electrode 6. A plating film 8 (not shown in FIG. 1) is formed on the outer electrodes 6 and 7.

The multilayer ceramic capacitor 1 is produced, for example, through the following steps. First, a ceramic slurry including a ceramic raw material powder having the composition described above is produced. Next, an appropriate sheet forming method is used to form the ceramic slurry into ceramic green sheets. Next, an electroconductive paste that later becomes the inner electrodes 4 and 5 is applied by, for example, printing to prescribed ones of the plurality of ceramic green sheets. Next, the plurality of ceramic green sheets are laminated and then pressure-bonded to obtain a green ceramic body. Next, the green ceramic body is fired. Through the firing step, the ceramic green sheets become the ceramic layers 3. Then the step of forming the outer electrodes 6 and 7 on end surfaces of the ceramic body 2 is performed, and then the step of forming the plating film 8 on the outer electrodes 6 and 7 is performed.

The electroconductive material for forming the outer electrodes 6 and 7 is initially in a sol state and includes (1) an electroconductive metal salt that, when fired, becomes an electroconductive metal serving as an electroconductive component, (2) a glass raw material that, when fired, becomes glass including silicon and includes a metal salt for the glass, and (3) a solvent to dissolve or disperse the electroconductive metal salt and the glass raw material. The glass raw material has a prescribed softening point and a prescribed melting point.

The electroconductive material in a sol state is applied to opposing end surfaces of the ceramic body 2 and then heat-dried, and the sol state is thereby converted to a gel state. The resulting electroconductive material is fired at a temperature higher than or equal to the softening point of the glass raw material, lower than or equal to the melting point of the glass raw material, and higher than or equal to the melting point of the metal salt for the glass, and the glass raw material is vitrified as a result. Since the firing temperature is higher than or equal to the softening point of the glass, lower than or equal to its melting point, and higher than or equal to the melting point of the metal salt for the glass, a large number of pores are formed uniformly in the outer electrodes 6 and 7 while adhesion between particles of the electroconductive metal in the glass in the outer electrodes 6 and 7 and adhesion between the outer electrodes 6 and 7 and an underlayer surface 10 are ensured.

More specifically, in cross sections of the outer electrodes 6 and 7 taken along their thickness direction, twenty or more submicron pores with a major axis of about 20 nm or more and about 600 nm or less are uniformly generated in a region located in a central portion with respect to the thickness direction and having a dimension of about 1 μm in the thickness direction and a dimension of about 5 μm in a width direction orthogonal to the thickness direction, for example.

Preferably, forty one or more pores are present in the above region, for example. No particular limitation is imposed on the upper limit of the number of pores. However, in Experimental Examples described later, the upper limit of the number of pores in the above region was found to be 227.

Preferably, the glass raw material included in the electroconductive material includes nano-silica and boric acid in addition to the metal salt for the glass.

The metal salt for the glass in the glass raw material includes, for example, lithium nitrate and sodium nitrate.

Preferably, the electroconductive metal salt included in the electroconductive material includes at least one of a metal nitrate or a metal carboxylate. The metal nitrate includes, for example, copper nitrate.

In the electroconductive material, the ratio of the content of the glass raw material to the content of the electroconductive metal salt is preferably about 0.04 or more and about 1.40 or less, for example, in terms of the ratio of the mass of the glass after conversion from the glass raw material to the mass of the metal after conversion from the electroconductive metal salt.

The solvent included in the electroconductive material includes, for example, diethylene glycol monoethyl ether.

The electroconductive material may contain an organic binder in order to adjust viscosity etc. Hydroxypropyl cellulose, for example, is advantageously used as the organic binder.

Although the details of the plating film 8 formed on the outer electrodes 6 and 7 is not illustrated, the plating film 8 includes, for example, a Cu plating layer, a Ni plating layer thereon, and a Sn plating layer thereon.

Example embodiments of the present invention have been described in relation to the outer electrodes of the multilayer ceramic capacitor. However, example embodiments of the present invention are applicable to any multilayer ceramic electronic component other than the multilayer ceramic capacitor so long as it is a multilayer ceramic electronic component including a ceramic body with a laminated structure including a plurality of laminated ceramic layers and inner electrodes disposed along interfaces between the ceramic layers, and outer electrodes on a surface of the ceramic body and electrically connected to the inner electrodes.

In the following Experimental Examples, copper was used as the electroconductive component in electroconductive materials for forming the outer electrodes 6 and 7. However, the electroconductive metal may be other than copper.

Next, the Experimental Examples performed to examine the advantageous effects of example embodiments of the present invention will be described.

### Production of Electroconductive Materials

The following (1) to (7) were mixed in amounts in % by mass shown in Table 1 to produce electroconductive materials in a sol state.
(1) Nano-silica having a diameter of 50 nm and surface-treated with methacrylic silane (“ADMANANO” manufactured by Admatechs Company Limited)
(2) Boric acid
(3) Lithium nitrate (melting point: 260°° C.)
(4) Sodium nitrate (melting point: 306°° C.)
(5) Copper (II) nitrate trihydrate
(6) hydroxypropyl cellulose (2.0 to 2.9 @20° C./2% aqueous solution)
(7) Diethylene glycol monoethyl ether

(1) to (4) above are used as a glass raw material that becomes glass when fired, and (3) and (4) are metal salts for the glass. (5) is an electroconductive metal salt that becomes an electroconductive metal when fired. (6) is an organic binder. (7) is a solvent.

Table 1 shows the ratio of the content of the glass raw material to the content of copper (II) nitrate trihydrate used as the electroconductive metal salt, i.e., “Glass/Cu” in terms of the ratio of the mass of the glass after conversion from the glass raw material to the mass of the metal after conversion from the electroconductive metal salt.

### Measurement of Softening Point and Melting Point of Glass Raw Material

The following solution was dried at 120° C. for 30 minutes:
Nano-silica having a diameter of 50 nm and surface-treated with methacrylic silane (“ADMANANO” manufactured by Admatechs Company Limited): 0.92% by mass.
Boric acid: 0.55% by mass.
Lithium nitrate: 0.29% by mass.
Sodium nitrate: 0.39% by mass.

The resulting dried solid product was subjected to TG-DTA (TP-1 manufactured by Rigaku) in N₂ under the following conditions. From the results of the TG-DTA, the softening point of the glass was estimated to be 545° C., and its melting point was estimated to be 716° C.
Room temperature to 950° C. (20° C./minute).
N₂ flow rate: 300 mL/minute.
Specimen container: alumina-made container.
Specimen amount: 10 mg.

### Application and Firing

End surfaces of ceramic bodies for multilayer ceramic capacitors (0.6 mm×0.3 mm×0.3 mm) including Ni inner electrodes were immersed in one of the electroconductive materials in a sol state, and the electroconductive material was dried at 120° C. for 30 minutes to gelate the electroconductive material. Opposite end surfaces of the ceramic bodies were also immersed in the electroconductive material, and the electroconductive material was dried.

Next, hydrogen gas was introduced into N₂, and firing was performed therein at 700° C., which is higher than or equal to the softening point of the glass, lower than or equal to its melting point, and equal to or higher than the melting points of the metal salts for the glass, and outer electrodes were thus formed as fired films including Cu particles and pores in the glass.

### Analysis of Structure of Outer Electrode

An outer electrode of one of the multilayer ceramic capacitors was used as a specimen, and FIB (focused ion beam) processing (“SMI-3050R” manufactured by Hitachi High-Tech Corporation) was performed at the center of a surface extending in the width and thickness directions of the multilayer ceramic capacitor. Then pores appearing on the processed surface were observed under an SIM (scanning ion microscope). More specifically, pores were observed in a region of the outer electrode having a dimension of about 1 μm in the thickness direction and a dimension of about 5 μm in the width direction orthogonal to the thickness direction. Then the “Number of pores,” the “Smallest pore,” and the “Largest pore” were determined as shown in Table 1. The “Number of pores” indicates the number of pores in the above region. The “Largest pore” indicates the major axis of the largest pore in the above region, and the “Smallest pore” indicates the major axis of the smallest pore in the above region.

### Plating

The outer electrodes were electroplated sequentially with Cu, Ni, and Sn under the following conditions to form a plating film.

### Cu Plating Conditions

Type of plating bath: Cu pyrophosphate plating bath (pH=8.6).
Bath temperature: 55° C.
Current value: 10 A.
Plating time: 90 minutes.

### Ni Plating Conditions

Type of plating bath: Watts bath (pH=4.0).
Bath temperature: 60° C.
Current value: 6 A.
Plating time: 51 minutes.

### Sn Plating Conditions

Type of plating bath: Neutral plating bath (pH=6.0).
Bath temperature: 25° C.
Current value: 3 A.
Plating time: 66 minutes.

### Measurement of Capacitance

An LCR meter (“HP4984A” manufactured by HEWLETT PACKARD) was used to measure the electrostatic capacitance of each multilayer ceramic capacitor specimen after the formation of plating under the condition of 1 kHz/0.5 Vrms. The measurement results were evaluated. Then, when a prescribed value was obtained, “o” was placed in the “Electrostatic capacitance” column in Table 1. When the prescribed value was not obtained, “x” was placed in the “Electrostatic capacitance” column.

### Evaluation of Moisture Resistance Reliability

The multilayer ceramic capacitor specimens were subjected to a PCBI (Pressure Cooker Bias Test)) under the conditions of a temperature of 125° C., a relative humidity of 95%, an applied voltage of 3.2 V, and a loading time of 72 hours, and the number of specimens was 15. The insulation resistance (IR) of each specimen was measured. When the value of Log IR at the end of the test was lower by 0.5 than that at the start of the test, the IR was considered to have deteriorated. When the deterioration of IR was not found in all the specimens, “o” was placed in the “Moisture resistance reliability” column in Table 1. When the deterioration of IR was found in some of the specimens, “x” was placed in the “Moisture resistance reliability” column.

TABLE 1

| | (% by mass) | | | | | | | |
|---|---|---|---|---|---|---|---|---|
| Specimen number | 1 | 2 | 3 | 4 | 5 | 6 | 7 | 8 |
| Nano-silica | 3.24 | 2.43 | 1.43 | 1.01 | 0.51 | 0.32 | 0.14 | 0.09 |
| Boric acid | 1.97 | 1.45 | 0.86 | 0.60 | 0.30 | 0.19 | 0.09 | 0.05 |
| Lithium nitrate | 1.01 | 0.75 | 0.45 | 0.31 | 0.16 | 0.10 | 0.04 | 0.03 |
| Sodium nitrate | 1.38 | 1.03 | 0.61 | 0.43 | 0.22 | 0.14 | 0.06 | 0.04 |
| Copper(II) nitrate | 10.95 | 13.79 | 17.69 | 19.37 | 21.71 | 21.96 | 22.72 | 23.01 |
| trihydrate | | | | | | | | |
| Hydroxypropyl cellulose | 11.60 | 11.60 | 11.60 | 11.60 | 11.60 | 11.60 | 11.60 | 11.60 |
| Diethylene glycol | 54.03 | 54.28 | 54.17 | 54.11 | 53.71 | 54.16 | 54.09 | 54.01 |
| monoethyl ether | | | | | | | | |
| Glass/Cu (mass ratio) | 2.21 | 1.39 | 0.57 | 0.37 | 0.16 | 0.11 | 0.04 | 0.03 |
| Number of pores | 28 | 41 | 159 | 227 | 135 | 92 | 75 | 2 |
| Smallest pore (nm) | 20 | 20 | 20 | 20 | 20 | 20 | 20 | 930 |
| Largest pore (nm) | 50 | 90 | 120 | 90 | 200 | 150 | 530 | 1070 |
| Moisture resistance | ○ | ○ | ○ | ○ | ○ | ○ | ○ | × |
| reliability | | | | | | | | |

In Table 1, specimens 1 to 7 satisfy the condition that twenty or more pores with a major axis of about 20 nm or more and about 600 nm or less are present. In these specimens 1 to 7, the “Moisture resistance reliability” was rated “o.” However, in specimen 8 that does not satisfy the above condition, the “Moisture resistance reliability” was rated “x.”

In the multilayer ceramic capacitors in specimens 1 to 7, the electric continuity and adhesion in the outer electrodes are ensured, and fine pores are highly dispersed in the outer electrodes, so that each multilayer ceramic capacitor has a structure in which hydrogen atoms can be gasified. Therefore, diffusion of hydrogen generated during plating and entering the outer electrodes into the ceramic layers can be reduced, and the deterioration of the insulation resistance can be prevented.

Although not shown in Table 1, the electrostatic capacitance was also evaluated. Then it was confirmed that the electrostatic capacitance was not problematic in each of specimens 1 to 8.

Attention is next focused on the “Glass/Cu” in Table 1. In specimens 2 to 7, the “Glass/Cu” is within the range of 0.04 or more and 1.40 or less, and the “Moisture resistance reliability” is rated “o.” This indicates that the “Glass/Cu” is more preferably in the range of 0.04 or more and 1.40 or less.

In specimens 2 to 7, the “Number of pores” is within the range of 41 or more and 227 or less. Therefore, the “Number of pores” is more preferably in the range of 41 or more and 227 or less.

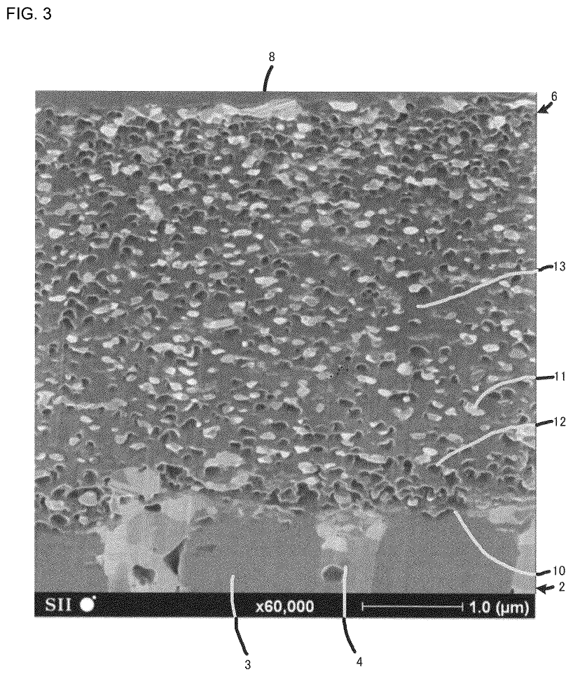

FIG. 3 is an SIM image of a cross section obtained by subjecting an outer electrode of specimen 5 to FIB processing. In FIG. 3, components corresponding to the components shown in FIGS. 1 and 2 are designated by the same reference numerals as those in FIGS. 1 and 2.

In FIG. 3, a portion appearing in the lower portion is an end surface of the ceramic body 2 from which the inner electrodes 4 are drawn, and the outer electrode 6 is located on this end surface. In the outer electrode 6, brighter spots are Cu 11, and darker spots more densely distributed near the end surface of the ceramic body 2 are pores 12. Gray regions other than the above spots are glass 13.

Although not shown in Table 1, a specimen in a Comparative Example was produced using the same procedure as that for specimen 5 except that lithium nitrate and sodium nitrate were eliminated from the solution composition of the electroconductive material in a sol state for specimen 5. The results show that, in the Comparative Example, delamination of the outer electrodes was found after firing and plating. This may be because of the following reason. Since the metal salts (lithium nitrate and sodium nitrate) that are heated above their melting points during firing are not present, fusion in the outer electrodes and on the underlayer surfaces of the outer electrodes is unlikely to proceed, so that adhesion of the outer electrodes cannot be ensured.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic electronic component comprising:
a ceramic body including a plurality of ceramic layers and an inner electrode extending along an interface between adjacent ones of the plurality of ceramic layers;
an outer electrode on a surface of the ceramic body and electrically connected to the inner electrode; and
a plating film on the outer electrode; wherein the outer electrode includes an electroconductive metal and glass including silicon; and
in a cross section of the outer electrode that is taken along a thickness direction of the outer electrode, twenty or more pores with a major axis of about 20 nm or more and about 600 nm or less are present in a region located in a central portion with respect to the thickness direction and having a dimension of about 1 μm in the thickness direction and a dimension of about 5 μm in a width direction orthogonal to the thickness direction.

2. The multilayer ceramic electronic component according to claim 1, wherein a number of pores present in the region is 41 or more.

3. The multilayer ceramic electronic component according to claim 1, wherein a number of pores present in the region is 227 or less.

4. The multilayer ceramic electronic component according to claim 1, wherein the multilayer ceramic electronic component is a multilayer ceramic capacitor.

5. The multilayer ceramic electronic component according to claim 1, wherein the glass includes a metal salt.

6. The multilayer ceramic electronic component according to claim 1, wherein the electroconductive material includes an electroconductive metal salt including at least one of metal nitrate or a metal carboxylate.

7. A method for producing a multilayer ceramic electronic component including a ceramic body including a plurality of laminated ceramic layers and an inner electrode located along an interface between adjacent ones of the ceramic layers, an outer electrode on a surface of the ceramic body and electrically connected to the inner electrode, and a plating film on the outer electrode, the method comprising;
preparing an electroconductive material in a sol state that includes (1) an electroconductive metal salt that, when fired, becomes an electroconductive metal serving as an electroconductive component, (2) a glass raw material that, when fired, becomes glass including silicon and includes a metal salt for the glass, and (3) a solvent to dissolve or disperse the electroconductive metal salt and the glass raw material, the glass raw material having a prescribed softening point and a prescribed melting point;
applying the electroconductive material to the surface of the ceramic body such that the electroconductive material comes into contact with the inner electrode in order to form the outer electrode;
heat-drying the electroconductive material to gelate the electroconductive material;
performing firing at a temperature higher than or equal to a softening point of the glass raw material, lower than or equal to a melting point of the glass raw material, and higher than or equal to a melting point of the metal salt for the glass to form the outer electrode; and
forming the plating film on the outer electrode.

8. The method for producing a multilayer ceramic electronic component according to claim 7, wherein the glass raw material further includes nano-silica and boric acid in addition to the metal salt for the glass.

9. The method for producing a multilayer ceramic electronic component according to claim 7, wherein the metal salt for the glass includes lithium nitrate and sodium nitrate.

10. The method for producing a multilayer ceramic electronic component according to claim 7, wherein the electroconductive metal salt includes at least one of a metal nitrate and a metal carboxylate.

11. The method for producing a multilayer ceramic electronic component according to claim 10, wherein the metal nitrate includes copper nitrate.

12. The method for producing a multilayer ceramic electronic component according to claim 7, wherein a ratio of a content of the glass raw material to a content of the electroconductive metal salt is about 0.04 or more and about 1.40 or less in terms of a ratio of a mass of the glass after conversion from the glass raw material to a mass of the metal after conversion from the electroconductive metal salt.

13. The method for producing a multilayer ceramic electronic component according to claim 7, wherein the solvent includes diethylene glycol monoethyl ether.

14. The method for producing a multilayer ceramic electronic component according to claim 7, wherein the electroconductive material further includes an organic binder.

15. The method for producing a multilayer ceramic electronic component according to claim 14, wherein the organic binder includes hydroxypropyl cellulose.

16. The method for producing a multilayer ceramic electronic component according to claim 7, wherein a number of pores present in the region is 41 or more.

17. The method for producing a multilayer ceramic electronic component according to claim 7, wherein a number of pores present in the region is 227 or less.

18. The multilayer ceramic electronic component according to claim 7, wherein the multilayer ceramic electronic component is a multilayer ceramic capacitor.
